(19) United States
(12) Patent Application Publication
(10) Pub. No.: US 2009/0195388 A1
(43) Pub. Date: Aug. 6, 2009

(54) FLOW LINE RECOGNITION SYSTEM

(75) Inventors: Tomonori Ikumi, Shizuoka (JP); Takashi Koiso, Kanagawa (JP); Masaki Narahashi, Tokyo (JP); Masami Takahata, Tokyo (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/366,040

(22) Filed: Feb. 5, 2009

(30) Foreign Application Priority Data
Feb. 5, 2008 (JP) 2008-025519

(51) Int. Cl. G08B 13/14

(52) U.S. Cl. 340/572.1

(57) ABSTRACT

A flow line recognition system comprises a first information recording unit which records a position of a mobile object in a monitoring area together with a time, a second information recording unit which records a position of the mobile object in a specified area together with a time, and a flow line information generation unit which generates flow line information of the mobile object on the basis of the monitoring area mobile object information and the specified area mobile object information.

### CROSS-REFERENCE TO RELATED APPLICATION

This application is based upon and claims the benefit of priority from prior Japanese Patent Application No. 2008-025519, filed Feb. 5, 2008, the entire contents of which are incorporated herein by reference.

### TECHNICAL FIELD

The present invention relates to a flow line recognition system which recognizes movement paths of customers moving in a store as flow lines.

### BACKGROUND

Conventional flow line recognition systems include a system using camera images and a system using radio tags.

Jpn. Pat. Appln. KOKAI Publication No. 2006-350751 discloses a flow line recognition system using camera images. Jpn. Pat. Appln. KOKAI Publication No. 2004-214737 discloses a flow line recognition system using radio tags.

The flow line recognition system using a camera images is appropriate for a small-sized supermarket, a convenience store, etc. However, this system requires many cameras in order to cover the whole area of a store. Such increase in the number of cameras requires a recording device with a large capacity in order to record photographed images. The control of each camera is troublesome, and the maintenance cost is markedly high. Therefore, this system is not suitable for shops with a sales floor space as large as a supermarket.

The flow line recognition system using radio tags does not use image data of a large data volume. Thereby, in comparison to a system using camera images, a system using radio tags can greatly reduce the required storage capacity. However, the resolution of position detection, namely, the degree of how precisely positions of mobile objects are specified is roughly dependent on the number of the radio tag readers. An increase in the number of radio tag readers enhances the resolution of position detection. However, such increase in the number of the tag readers tends to generate electric wave interference among the radio tag readers, the occurrence of which deteriorates the data reading precision of the radio tags. Therefore, there is a physical limit to the number of radio tag readers to be installed within a monitoring area. Thus, a system using radio tags has to be low in resolution in comparison with a system using camera images.

As mentioned above, as regards the conventional flow line recognition system, whichever system is adopted, the camera image system or radio tag system, poses a problem for use in a wide monitoring area.

### SUMMARY

An object of the invention is to provide a flow line recognition system which is effective even in a wide monitoring area.

According to an aspect of the invention, there is provided a flow line recognition system comprising: a first information recording unit which records a position of a mobile object in a monitoring area together with a time; a second information recording unit which records a position of the mobile object in a specified area together with a time; and a flow line information generation unit which generates flow line information of the mobile object on the basis of the monitoring area mobile object information and the specified area mobile object information.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary plane view of a store to which an embodiment of the invention is applied;

FIG. 2 is an exemplary view depicting a shopping basket for use in the embodiment of the invention;

FIG. 3 is an exemplary block diagram depicting a configuration of a substantial part of a flow line recognition system that is the embodiment of the invention;

FIG. 4 is an exemplary view depicting a structure of data stored in a radio tag flow line database;

FIG. 5 is an exemplary view depicting a structure of data stored in a camera flow line database;

FIG. 6 is an exemplary schematic view for explaining a specified area;

FIG. 7 is an exemplary view depicting a structure of data stored in a specified area database;

FIG. 8 is an exemplary view depicting a structure of data stored in a forward and backward flow line database;

FIG. 9 is an exemplary view depicting a structure of a final flow line file stored in a final flow line database;

FIG. 10 is an exemplary flow chart depicting a processing procedure of a forward and backward determination unit;

FIG. 11 is an exemplary flowchart depicting a processing procedure of a final flow line generation unit; and

FIG. 12 is an exemplary flowchart depicting a processing procedure of a flow line coupling unit.

### DETAILED DESCRIPTION

An embodiment will be described in a case where the invention is applied to a flow line recognition system which recognizes movement paths of customers moving in a store 1 as flow lines.

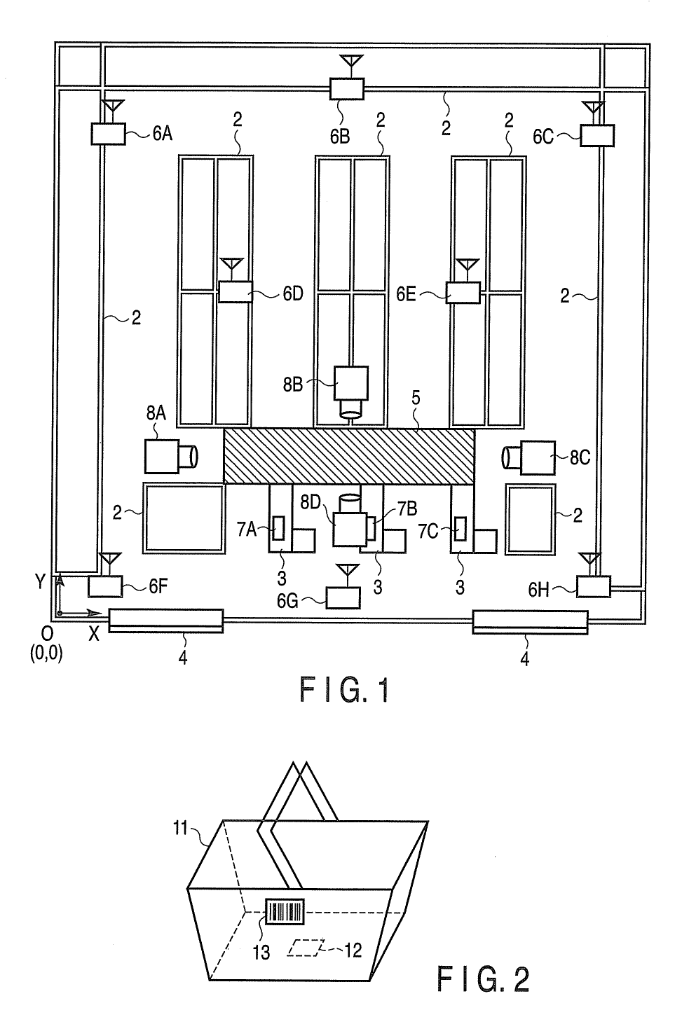

FIG. 1 shows a layout of the store 1. A store area includes a monitoring area. The monitoring area excludes an area in which commodity racks 2 and check out counters 3 are installed from the store area. The monitoring area includes a specified area. The specified area is an area 5 shown by hatching in FIG. 1, namely, this side of the counter 3. A flow line recognition system recognizes a movement path on which a customer who has entered from any gateway 4 moves in the monitoring area and the specified area 5 to get out of the store 1 through any gateway 4 as a flow line.

The flow line recognition system uses both a radio tag system and a camera image system. The specified area 5 adopts the camera image system, and the monitoring area other than the specified area 5 adopts the radio tag system.

In the recognition system, a plurality (eight in FIG. 1) of radio tag readers 6A-6H are dispersed at key points in the monitoring area. In FIG. 1, each radio tag reader 6A-6H may be installed at any point on a ceiling, a floor, racks, walls, etc.

Each radio tag reader 6A-6H makes radio communications with radio tags 12 which are each present in its own communication area. The radio tags store proper tag identification information, so-called, tag IDs in advance therein. Each radio tag reader 6A-6H reads the tag ID stored in the radio tag through radio communications. Each radio tag reader 6A-6H functions as a base station having a function of detecting the positions of radio tags 12.

As shown in FIG. 2, every radio tag 12 is attached to the shopping basket 11 used in the store 1 by each customer. Each customer moves through the store 1 while holding the shopping basket 11 or carrying the shopping basket 11 on a shopping cart. Therefore, the radio tag 12 moves in the store 1 together with the customer, who is a mobile object.

A barcode label 13 is attached to the shopping basket 11. The barcode of the barcode label 13 indicates the tag ID of the radio tag 12 attached to the shopping basket 11.

Each check out counter 3 is provided with a scanner 7A-7c. Each scanner 7A-7C reads the barcode of the barcode label 13 from the shopping basket 11 placed on the counter 3.

A plurality (four in FIG. 1) cameras 8A-8D are dispersed in each circumferentially specified area 5. Each camera 8A-8D may be installed at any part on the ceiling racks, etc., as long as the customers moving in the specified area 5 can be photographed from the positions shown in FIG. 1.

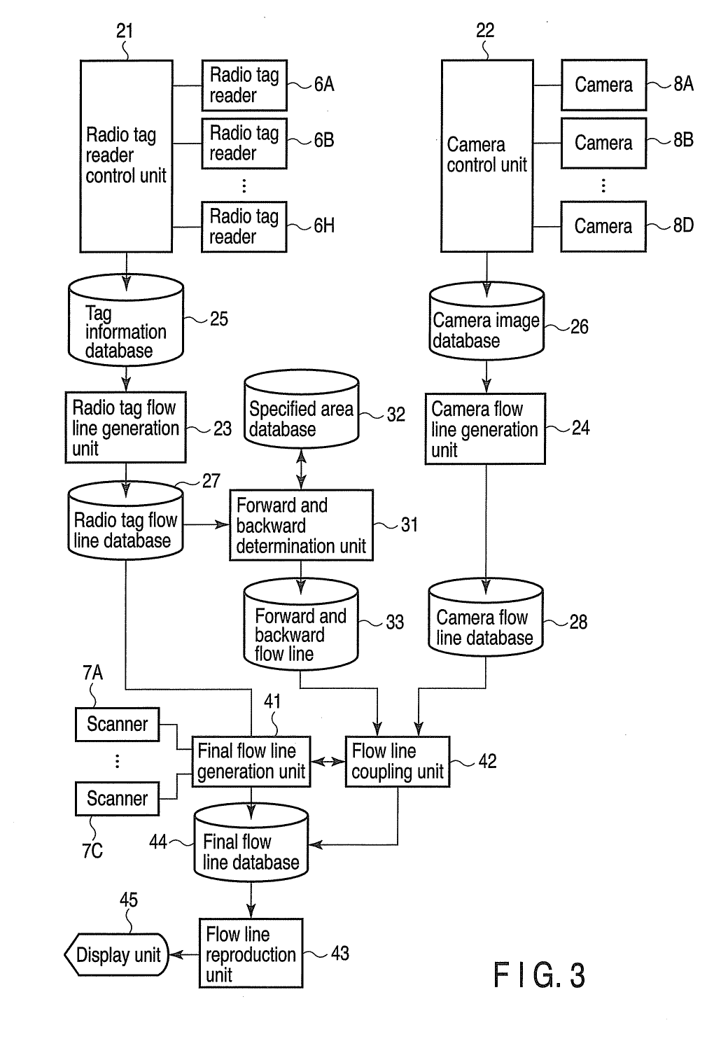

The block diagram of FIG. 3 shows a configuration of a substantial part of the flow line recognition system. The recognition system includes a radio tag reader control unit 21, a camera control unit 22, a radio tag flow line generation unit 23, a camera flow line generation unit 24, a tag information database 25, a camera image database 26, a radio tag flow line database 27, and a camera flow line database 28.

The tag reader control unit 21 controls reading operations of the plurality of the radio tag readers 6A-6H. The tag reader control unit 21 associates the tag IDs of the radio tags 12 read by the respective radio tag readers 6A-6H with reader identification information and the read times to record the associated items in the tag information database 25. Each radio tag reader 6A-6H is individually identified by the reader identification information.

The radio tag flow line generation unit 23 uses the data recorded in the tag information database 25 to generate flow line information of each radio tag 12. The radio tag flow line generation unit 23 utilizes the wireless LAN technique standard IEEE 802.11 b/g. That is, the flow line generation unit 23 uses both a three-side measurement system based on a Time Difference of Arrival (TDOA) of response radio waves from the same radio tag 12 to each radio tag reader 6A-6H and a Receiver Signal Strength Indicator (RSSI) of the response radio waves to detect the position of each radio tag 12.

After detecting the position of the radio tag 12, the radio tag flow line generation unit 23 converts the position into X-Y plane coordinates (X, Y) within the monitoring area. In the embodiment, the lower left corner of the store 1 shown in FIG. 1 is set to an original point “O” (0, 0) of the X-Y plane coordinates.

After converting the position of the radio tag 12 into the coordinates (X, Y), the flow line generation unit 23 generates flow line information from the coordinate information S, the tag ID of the radio tag 12 and the detection time. The detection time is the time at which the radio tag 12 is read. The flow line generation unit 23 records the flow line information in the flow line database 25.

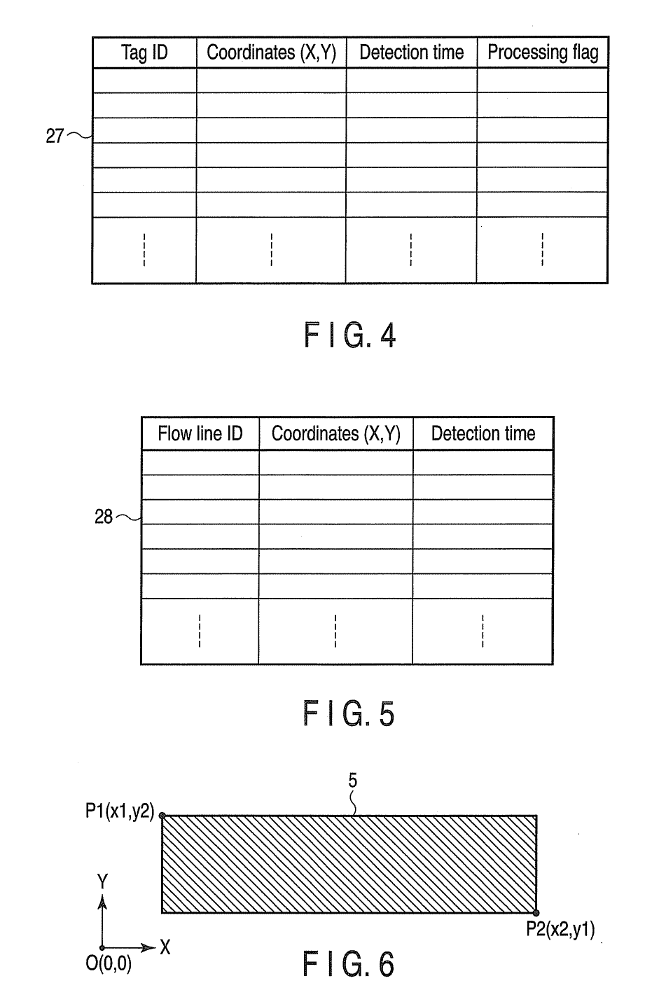

FIG. 4 shows a data structure of the flow line database 25. In FIG. 4, a processing flag is set to “0” when the corresponding-flow line information (tag ID, coordinate, detection time) is recorded in the flow line database 25. When the flow line information is processed by a final flow line generation unit 41, the processing flag is set to “1”. The processing by the final flow line generation unit 41 will be described below.

The camera control unit 22 controls an photographing operation of each camera 8A-8D. The camera control unit 22 sequentially takes in images photographed by cameras 8A-8D to record the images in the camera image database 26 together with information of photographing times.

The camera flow line generation unit 24 generates flow line information for each mobile object on the basis of the data of the camera image recorded in the camera image database 26. At this moment, the camera flow line generation unit 24 processes the images photographed by the plurality of cameras 8A-8D by means of a known visual volume intersection method to extract the mobile objects. When extracting the mobile objects, the flow line generation unit 24 traces these mobile objects. At this time, the flow line generation unit 24 issues a proper flow line ID number for each mobile object.

The flow line generation unit 24 measures the positions of the mobile objects in the process of tracking at fixed periods. The flow line generation unit 24 converts the measured positions into X-Y plane coordinates (X, Y) in the monitoring area.

After converting the positions of the mobile objects into the coordinates (X, Y), the camera flow line generation unit 24 generates flow line information from the coordinate information, the flow line IDs of the mobile objects and the detection times. The detection times are equivalent to the photographed times of the images from which the mobile objects have been extracted. The flow line generation unit 24 records the flow line information in the camera flow line database 28. FIG. 5 shows the data structure of the camera flow line database 25.

The system using the visual volume intersection method using the camera images may obtain a high resolution to an extent of several tens of centimeters, in comparison with the system using radio tags. Therefore, the flow line in the specified area 5 may be detected with high precision in comparison with other places in the monitoring area.

The flow line recognition system further comprises a forward and backward determination unit 31, a specified area database 32, and a forward and backward flow line database 33.

The specified area 5 has a rectangular shape on the X-Y plane as shown in FIG. 6. Thus, when the X-Y plane coordinates of a point P1 at the left upper end to the original point O (0, 0) are defined as (x1, y2), and the X-Y plane coordinates of a point P2 at the right lower end to the original point O (0, 0) are defined as (x2, y1), the specified area 5 becomes a set of each point coordinate of the range of the X-coordinates is x1-x2, and of the range of the Y-coordinate is y1-y2.

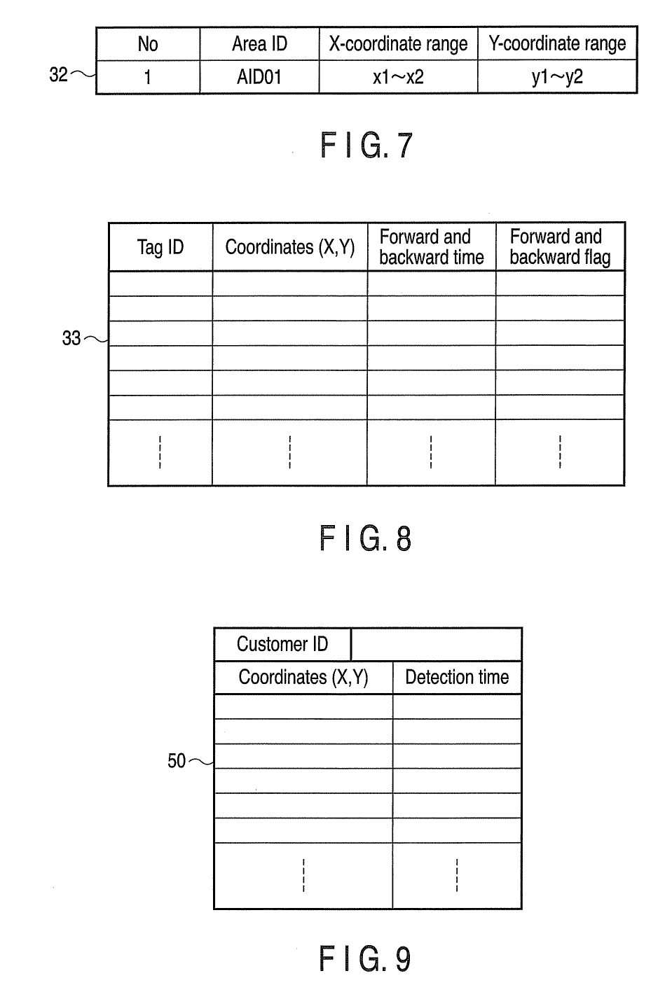

As shown in FIG. 7, the specified area database 32 stores each point coordinate in the specified area 5 in correspondence to area IDs that identify the specified areas 5, namely, the X-coordinates up to the range x1-x2, and the Y-coordinates up to the range y1-y2.

The forward and backward determination unit 31 refers to the specified area database 32. The determination unit 31 determines whether or not the radio tag flow line information recorded in the radio tag flow line database 27 is the information at the time point when the radio tag 12 has entered the specified area 5. The determination unit 31 also determines whether or not the radio tag flow line information is the information at the time point when the radio tag 12 has exited the specified area 5. The determination unit 31 records the radio tag flow line information at the time point when the radio tag has entered or exited the specified area 5 in the flow line database 33.

FIG. 8 shows a data structure of the flow line database 33. In FIG. 8, the forward and backward time is the detection time of the radio tag flow line information. The forward and backward flag is defined as “1” if the radio tag flow line information shows the information at the time point when the radio tag 12 has entered the specified area 5, and is defined as “0” if the radio tag flow line information shows the information at the time point when the radio tag 12 has exited the specified area 5. The flag may be defined so that the definition of “1” and “0” is reverse to each other.

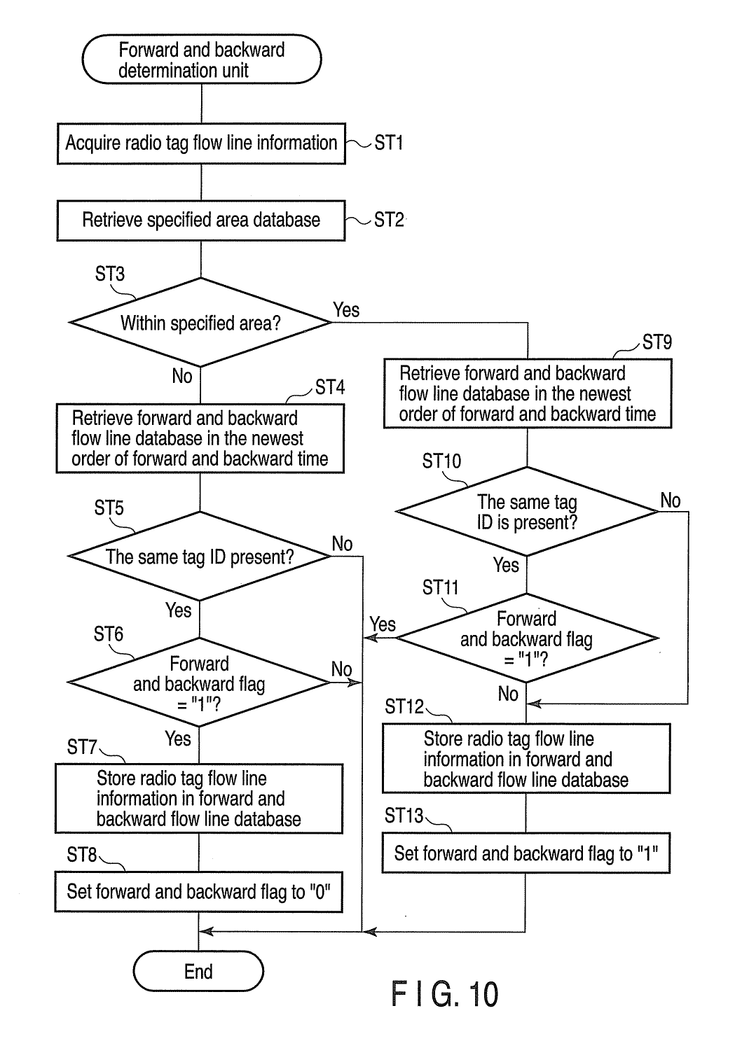

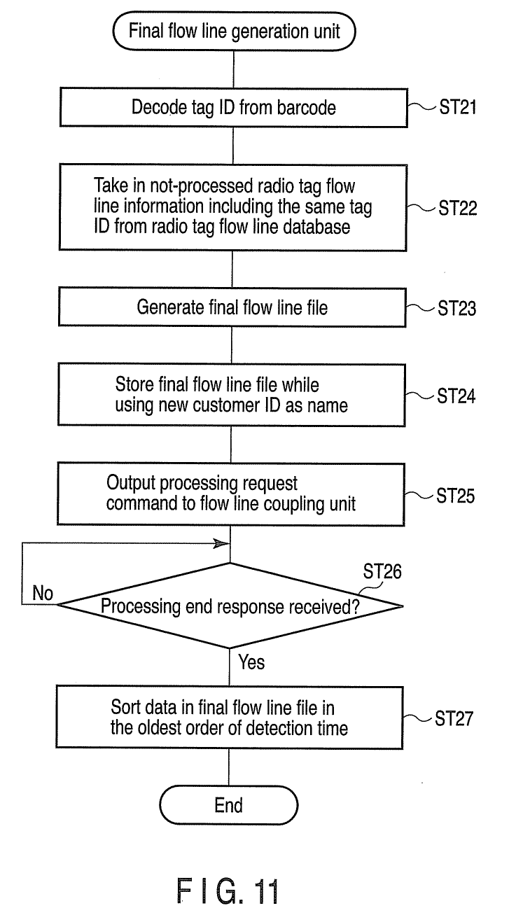

The determination unit 31 determines the forward and backward flag of the mobile objects (radio tags 12) for the specified area 5 in a procedure shown in a flowchart of FIG. 10 every time the radio tag flow line information is written in the radio tag flow line database 27.

The forward and backward determination unit 31 firstly acquires the radio tag flow line information (tag ID, X-Y coordinates, detection time) written in the flow line database 27 in step ST1. Then, the determination unit 31 retrieves the specified area database 32 by means of the X-Y coordinate information in the radio tag flow line information in Step ST2. The determination unit 31 determines whether or not the position shown by the X-Y coordinate information is in the specified area 5 in Step ST3.

If both the X-coordinate and Y-coordinate are inside the coordinate range of the specified area 5, the determination unit 31 determines that the radio tag flow line information is the information within the specified area 5. If at least any one of the X-coordinate and Y-coordinate is outside the coordinate range of the specified area 5, the determination unit 31 determines that the radio tag flow line information is the information out of the specified area 5.

If it is determined that the information is the radio tag flow line information out of the specified area 5 (NO, Step ST3), the determination unit 31 uses the tag ID of the radio tag flow line information as a retrieval key to retrieve the forward and backward flow line database 33 in the newest order of forward and backward time in Step ST4. As a result, if the forward and backward flow line information in which the same tag ID as that of the retrieval key has been set cannot be retrieved from the database 33 (NO, Step ST5), the radio tag flow line information is not the information of the time point when the radio tag 12 has exited the specified area 5. In this case, the determination unit 31 ends the processing for the radio tag flow line information.

As the result of the retrieval of the database 33, if the forward and backward information in which the same tag ID as that of the retrieval key has been set is detected (YES, Step ST5), the determination unit 31 checks the forward and backward flag in the flow line information detected from the database 33 in Step ST6. If the forward and backward flag is not set to “1”, namely, set to “0” (NO, Step ST6), the radio tag flow line information is the information of the radio tag 12 which has already exited the specified area 5. In this case, the determination unit 31 ends the processing for the radio tag flow line information.

If the flag is set to “1” (YES, Step ST6), the radio tag flow line information is the information of the radio tag 12 which has just exited the specified area 5. In this case, in Step ST7, the determination unit 13 adds the radio tag flow line information to the forward and backward flow line database 33 as new forward and backward flow line information. The determination unit 31 also sets the flag of the flow line information to “0” in Step ST8. With that, the determination unit 31 ends the processing for the radio tag flow line information.

Conversely, as the result of retrieval of the specified area database 32 through the X-Y coordinate information in the radio tag flow line information, if it is determined that the information is the radio tag flow line information in the specified area 5 (YES, Step ST3), the determination unit 31 uses the tag ID of the radio tag flow line information as a retrieval key to retrieve the forward and backward flow line database 33 in the newest order of forward and backward time in Step ST9. As a result, if the forward and backward flow line information in which the same tag ID as that of the retrieval key has been set cannot be retrieved from the database 33 (YES, Step ST10), the radio tag flow line information is the information of the time point when the radio tag 12 has entered the specified area 5. In this case, the determination unit 31 adds the radio tag flow line information to the forward and backward flow line database 33 as new forward and backward information in Step ST12. The determination unit 31 also sets the flag 1 of the added forward and backward flow line information to “1”. With that, the forward and backward determination unit 31 ends the processing to the radio tag flow line information.

As the result of the retrieval of the database 33, if frontward and backward flow line in which the same tag ID as the retrieval key is set is detected (YES, Step ST10), the determination unit 31 checks the forward and backward flag in the forward and backward flow line detected from the database 33 in Step ST11. If the flag is not set to “1”, namely, set to “0”, the radio tag flow line information is the information of the radio tag 12 at the time when the radio tag 12 re-enters the specified area 5 after once exiting the specified area 5. In this case, the determination unit 31 also executes the processing in Steps ST12, ST13 to end the processing for the radio tag flow line information.

If the flag is set to “1”, the radio tag flow line information is the information of the radio tag 12 which has already entered the specified area 5. In this case, the determination unit 31 ends the processing for the radio tag flow line information.

While the processing of the foregoing procedure through the determination unit 31 is being executed, the radio tag flow line information (flag is set to “1”) at the time when the radio tag 12 has entered the specified area 5 and the radio tag flow line information (flag is set to “0”) at the time when the radio tag 12 has exited the specified area 5 are recorded in chronological order in the forward and backward flow line database 33. The determination unit 31 composes an entering determination unit and an exiting determination unit.

The flow line recognition system further includes a final flow line generation unit 41, a flow line coupling unit 42, a flow line reproduction unit 43, a final flow line database 44 and a display unit 45. For instance, a color display is used for the display unit 45.

The final flow line generation unit 41 generates a final flow line for each customer in a procedure shown in a flowchart of FIG. 11 every time each scanner 7A-7C reads the barcode of the barcode label 13 attached to the shopping basket 11.

The final flow line generation unit 41 decodes the tag ID of the radio tag 12 from the data of the barcode read by each scanner 7A-7C in Step ST21. After decoding the tag ID, the generation unit 41 uses the tag ID as the retrieval key to retrieve the radio tag flow line database 27 in Step ST22. The generation unit 41 takes in all items of the flow line information in which the processing flag is set to “0” in the oldest order of detection time from among the items of radio tag flow line information with the tag ID matching the retrieval key set therein. The generation unit 41 rewrites all the processing flags of the taken flow line information into “1”.

The generator 41 generates a final flow line file 50 of the data structure shown in FIG. 9 in Step ST23. The generation unit 41 sequentially stores each item of information of the X-Y plane coordinates and the detection time of all items of radio tag flow line information taken in from the radio tag flow line database 27 in the final flow line file 50. After storing the above, the generation unit 41 generates a new customer ID in Step ST24. The generation unit 41 generates a file name by using the customer ID, and stores the final flow line file 50 in the final flow line database 44.

The generation unit 41 issues a processing request command for the flow line coupling unit 42 in Step ST25. The request command includes the new customer ID, the tag ID decoded from the barcode data, and the information of the oldest detection time among the items of the information of detection times of all items of radio tag flow line information taken in from the radio tag flow line database 27. The generation unit 41 outputs the request command to the coupling unit 42.

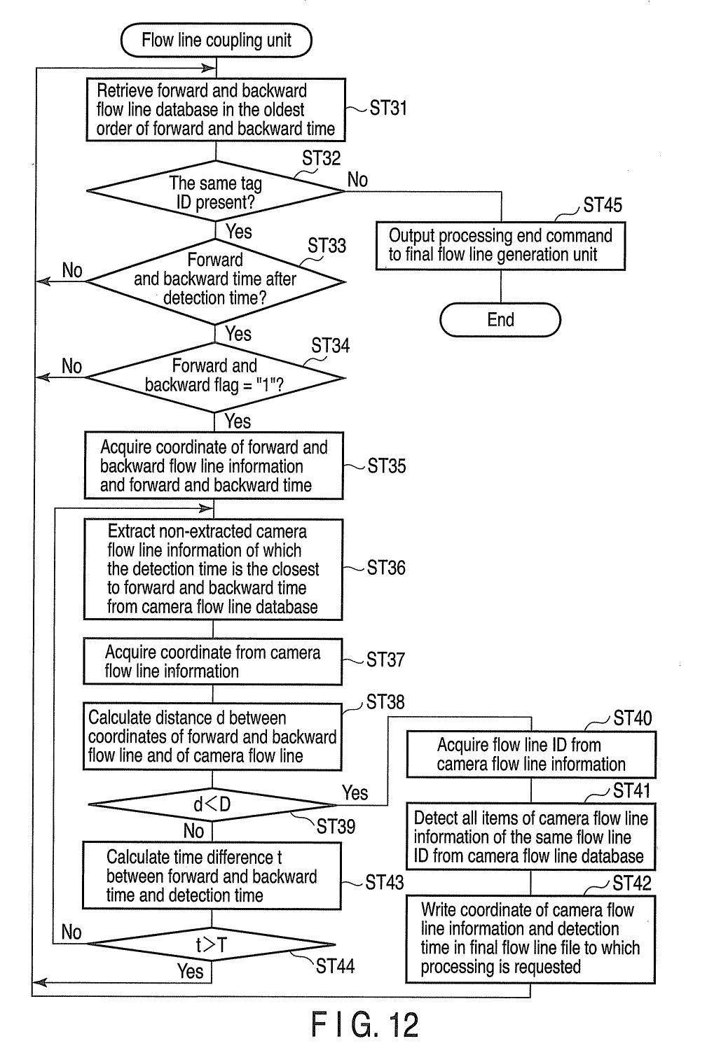

When the processing request command is input from the generation unit 41, the coupling unit 42 couples the camera flow line information with the forward and backward flow line information in a procedure shown in a flowchart of FIG. 12.

The coupling unit 42 retrieves the database 33 in the oldest order of forward and backward times by using the tag ID included in the request command as the retrieval key. If the forward and backward information of the tag ID coincide with the retrieval key (YES, Step ST32), the coupling unit 42 executes the processing in each of Steps ST33-ST34.

The coupling unit 42 determines whether or not the forward and backward time of the forward and backward flow line information detected in Step ST33 is the time which is at or after the detection time included in the request command. If the forward and backward time is the time before the detection time (NO, Step ST33), the forward and backward information is the information of the customer who has purchased by using the same shopping basket 11 earlier than the customer who has been assigned the customer ID included in the processing request command. In this case, the coupling unit 42 returns to the retrieval processing for the database 33.

If the forward and backward time is at or after the detection time (YES, Step ST33), this forward and backward information is the information of the customer who has been assigned the customer ID included in the request command. In this case, the coupling unit 42 checks the forward and backward flag in the forward and backward information in Step ST34.

If the flag has not been set to “1” (NO, Step ST34), the forward and backward flow line information is the information at the time point when the radio tag 12 has exited the specified area 5. In this case, the coupling unit 42 returns to the retrieval processing of the database 33.

If the flag has been set to “1” (YES, Step ST34), the forward and backward information is the information at the time point when the radio tag 12 has entered the specified area 5. In this case, the coupling unit 42 acquires the information of the X-Y coordinates and the forward and backward time from the forward and backward information in Step ST35.

The coupling unit 42 retrieves the camera flow line database 28 in Step ST 36. The coupling unit 42 then extracts one item of the camera flow line information of which the detection time is the closest time to the forward and backward time.

The coupling unit 42 acquires the X-Y coordinates of the camera flow line information in Step St 37. The coupling unit 42 calculates a distance d to a point indicated by the X-Y coordinates of the forward and backward information from the point indicated by the X-Y coordinates in Step ST38.

The coupling unit 42 determines whether or not the distance d is shorter than a prescribed threshold D in Step ST39. The threshold D is set not longer than one meter, for example, 80 centimeters.

If the distance d is shorter than the threshold D (YES, Step ST39), the camera flow line information and the forward and backward flow line information are the flow line of the same customer. In this case, the coupling unit 42 acquires a flow line ID from the camera flow line information in Step ST40. The coupling unit 42 uses the flow line ID as the retrieval key in Step 41 to retrieve the database 28, and loads all items of the camera flow line information with the same flow line ID as the retrieval key set therein.

After loading the camera flow line information, the flow line coupling unit 42 opens the final flow line file 50 of which the file name is the customer ID included in the processing request command from the final flow line database 44 in Step ST42. The coupling unit 42 sequentially writes, in the file 50, the X-Y coordinates and the information of the detection times of all items of the camera flow line information taken from the database 28.

If the distance d is the threshold D or longer (NO, Step ST39), the camera flow line information and the forward and backward flow line information are the flow line information of another customer. In this case, the coupling unit 42 calculates a time difference t between the detection time of the camera flow line information and the forward and backward time of the forward and backward information in Step ST43. When calculating the time difference t, the coupling unit 42 determines whether or not the time difference t exceeds a prescribed threshold T in Step ST44. It is assumed that the threshold T is set to one minute or shorter, for example, to 30 seconds.

If the time difference t does not exceed the threshold T (NO, Step ST43), the coupling unit 42 continues to retrieve the camera flow line database 28. The coupling unit 42 extracts information of which the detection time is the closest time to the forward and backward time from among items of un-extracted camera flow line information (Step ST36). After this, the coupling unit 42 executes again the processing in Steps ST37-ST44.

After writing the information of the X-Y coordinates and detection times of all the items of the camera flow line information taken from the database 28 in the final flow line file 50 in Step ST42, the coupling unit 42 returns to the processing in Step ST31. Likewise, the coupling unit 42 returns to the processing in Step ST31 in the case where the time difference t exceeds the predetermined threshold T.

In this way, the flow line coupling unit 42 uses the tag ID included in the processing request command as the retrieval key to retrieve the forward and backward flow line database 33 in the oldest order of forward and backward time. The coupling unit 42 executes the processing in Steps ST33-ST44 every time the forward and backward flow line information of the tag ID coincides with that of the retrieval key.

If the coupling unit 42 cannot retrieve the forward and backward information of the tag ID coinciding with the retrieval key (NO, Step ST32), the coupling unit 42 outputs the response command of the processing termination. This response command includes the customer command of the processing request command.

The final flow line generation unit 41 which has output the processing request command stands by the response command of the processing termination in Step ST26. If a response command of the processing termination is received from the coupling unit 42 (YES, Step ST26), the generation unit 41 opens the final flow line file 50 of which the file name is the customer ID in the request command from the final flow line database 44. The generation unit 41 rearranges the flow line information consisting of the coordinate information and the detection time information stored in the file 50 in the oldest order of the detection time.

Thus, the file 50 manages the final flow line information of the customer who is identified by the customer ID.

The flow line reproduction unit 43 reproduces the flow lines on a screen showing the inside of the store 1 on the display unit 45 in accordance with the final flow line information stored in the file 50. These flow lines in the monitoring area except for the specified area in the store 1 are recognized in the radio tag system, and these flow lines in the specified area 5 are recognized in the camera image system. Therefore, in the specified area 5, the position detection of the flow lines are performed with a resolution higher than that of other monitoring areas.

In a large-sized supermarket, generally, since customers who waiting for payment accounting and continuing shopping pass in the area on this side of the check out counter 3, the area is frequently congested. In the embodiment, the area on this side is defined as the specified area 5. Therefore, the flow line recognition system can recognize the flow lines of the customers moving in the specified area 5 with high resolution.

Meanwhile, the system adopts the radio tag system for areas other than the specified area 5. Although the radio tag system may not produce a resolution higher than that of the camera image system, the system has advantages of reducing costs needed to construct and maintain the system. The advantages become greater with in increase in the width of the monitoring area.

As mentioned above, according to the embodiment, a flow line recognition system which is effective to an object of which the monitoring area is wide may be provided.

The invention is not limited to the specific details and representative embodiments shown and described herein, and in an implementation phase, this invention may be embodied in various forms without departing from the spirit or scope of the general inventive concept thereof.

While the aforementioned embodiments have been described in the cases in which the first position detection means are configured by the radio tag systems, and the second position detection means are configured by the camera image systems, the invention is not limited to the embodiments. In short, it is sufficient for the second position detection means to have a resolution higher than that of the first position detection means.

While in the aforementioned embodiments, the radio tags 12 moving integrated with the customers that are mobile objects are attached to the shopping baskets, the invention is not limited to the cases of the embodiments. For instance, the system may hand cards, seals, etc., with the radio tags 12 attached thereto to customers and require the customers to keep them while they are in the store 1.

In the embodiment given above, the barcode label 13, indicating the tag ID of the radio tag 12 attached to the shopping basket 11, is attached to the shopping basket 11. Using the reading of the barcode of the barcode label 13 at the counter 13 as a trigger, the system proceeds into the generation processing of the final flow line. This is the reason why the system enters the generation processing of the final flow line, because the system cannot identify the customers one after another due to the repeated use of the same shopping basket 11 by many different customers.

In such a configuration may be eliminated by using a scheme in which the tag ID of the radio tag 12 attached to the shopping basket 11 brought into the counter 13 is automatically rewritten with a new ID. In a case of the use of such a scheme, it is not limited for timing of generating the final flow line at a time of check out. The processing flag may be eliminated from the radio tag flow line database 27.

While the specified area 5 is the area on this side of the check out counter 3 in the aforementioned embodiment, the invention is not limited to the case in which the specified area 5 is disposed in this area. The shape of the specified area is not limited to a rectangular shape.

According to another embodiment, it is also possible to dispose a plurality of specified areas 5 in the monitoring area. In such a case, systems each composed of the cameras 8A-8D, camera control unit 22, camera image database 26, camera flow line generation unit 24 and camera flow line database 28 are disposed by fitting an equal number of systems as number of areas. The forward and backward determination unit 31 adds area IDs of the specified areas 5 to the forward and backward information concerning the entry or exit from the specified areas 5. The flow line coupling unit 42 refers to the camera flow line database 28 of the systems to be identified by the area IDs in the forward and backward information. The coupling unit 42 couples the forward and backward information with the camera flow line information.

The foregoing embodiments have described the case in which the systems check the radio tag flow line information, i.e., entry to or exit from the specified area 5, so-called, forward and backward information, with the camera flow line information to couple the information of the same mobile object. However, in the invention, the flow line recognition system may check the radio tag flow line information with the camera flow line information to couple them.

By using the forward and backward flow line information as described in the embodiments, the number of items of the radio tag flow line information necessary for coupling determination may be reduced. As a result, the flow line coupling unit 42 produces an effect to extremely reduce the burden on processing.

While the embodiments have described examples where the condition to couple the forward and backward flow line information with the camera flow line information as the information of the same mobile object is defined the case in which the spaces of the positions shown by each item of the position information are prescribed value or less and also the differences between times shown by the time information are minimum, the coupling conditions are not limited to the examples.

While the embodiments have described the cases in which the forward and backward determination units 31 use the radio tag flow line information to determine the entry to the specified areas 5 and exit from specified areas 5, the invention may use camera flow line information.

In this case, the determination unit 31 determines whether or not the information is the camera flow line information recorded in the camera flow line database 28 at the time point of the mobile object entering the specified area 5, or at the time point of the mobile object entering the specified area 5. The determination unit 31 then records the camera flow line information at the time point of entering the specified area 5 or at the time point of exiting the specified area 5 in the forward and backward flow line database 33.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A flow line recognition system comprising:
a first position detection device which detects a position of a mobile object in a monitoring area;
a first information recording unit which records position information showing the position of the mobile object detected by the first position detection device as monitoring area mobile object information together with time information showing a time at which the mobile object has been in the position;
a second position detection device which detects a position of the mobile object in a specified area that is a part of the monitoring area in a system differing from that of the first position detection device;
a second information recording unit which records position information showing the position of the mobile object detected by the second position detection device as specified area mobile object information together with time information showing a time at which the mobile object has been in the position; and
a flow line information generation unit which generates flow line information showing a movement path of a mobile object moving in the monitoring area on the basis of the monitoring area mobile object information recorded in the first information recording unit and the specified area mobile object information recorded in the second information recording unit.

2. The system according to claim 1, wherein
the second position detection device detects the position of the mobile object in the specified area that is a part of the monitoring area with a resolution higher than that of the position detection by the first position detection device.

3. The system according to claim 1, wherein
the first position detection device is provided with a radio tag which moves integrated with the mobile object; and a plurality of radio tag reading units which are arranged in each place in the monitoring area to read, in a non-contact manner, tag identification information transmitted by radio from the radio tag.

4. The system according to claim 1, wherein
the second position detection device is provided with a camera which photographs inside the specified area; and an image processing unit which recognizes a mobile object from an image photographed with the camera to calculate a position of the mobile object.

5. The system according to claim 1, wherein
the first position detection device is provided with a radio tag which moves integrated with the mobile object; and a plurality of radio tag reading units which are arranged in each place in the monitoring area to read, in a non-contact manner, tag identification information transmitted by radio from the radio tag, and
the second position detection device is provided with a camera which photographs inside the specified area; and an image processing unit which recognizes a mobile object from an image photographed with the camera to calculate a position of the mobile object.

6. The system according to claim 1, wherein
the flow line information generation unit comprises a comparison unit which compares each item of position information and time information of the monitoring area mobile object information and the specified area mobile object information, respectively; and a coupling unit which couples monitoring area mobile object information and specified area mobile object information of which the difference in position information is a prescribed value or less and also of which the difference in time information is minimum as information of the same mobile object.

7. The system according to claim 6, further comprising:
an entering determination unit which determines whether or not the mobile object has entered the specified area on the basis of the position information of the mobile object detected by the first or second position detection device, wherein
the comparison unit compares monitoring area mobile object information of a mobile object determined to have entered the specified area by the entering determination unit from among items of the monitoring area mobile object information with the specified area mobile object information.

8. The system according to claim 6, further comprising:
an exiting determination unit which determines whether or not the mobile object has exited the specified area on the basis of position information of the mobile object detected by the first or second position detection device, wherein
the comparison unit compares monitoring area mobile object information of a mobile object determined to have exited the specified area by the exiting determination unit from among items of the monitoring area mobile object information with the specified area mobile object information.

9. A flow line recognition system comprising:
a first information recording unit which records position information showing a position of a mobile object in a monitoring area as monitoring area mobile object information together with time information showing a time at which the mobile object has been in the position;
a second information recording unit which records position information showing a position of the mobile object in a specified area that is a part of the monitoring area as specified area mobile object information together with time information showing a time at which the mobile object has been in the position; and
a flow line information generation unit which generates flow line information showing a movement path of a mobile object moving in the monitoring area on the basis of the monitoring area mobile object information recorded in the first information recording unit and the specified area mobile object information recorded in the second information recording unit.

10. The system according to claim 9, wherein
the flow line information generation unit comprises a comparison unit which compares each item of position information and time information of the monitoring area mobile object information and the specified area mobile object information, respectively; and a coupling unit which couples monitoring area mobile object information and specified area mobile object information and the specified area mobile object information of which the difference in position information is equivalent to a prescribed value or less and also of which the difference in time information is minimum as the same mobile object.

11. The system according to claim 10, further comprising:
an entering determination unit which determines whether or not the mobile object has entered the specified area on the basis of the position information showing a mobile object in the monitoring area, or position information showing a position of the mobile object in the specified area, wherein
the comparison unit compares monitoring area mobile object information of a mobile object determined to have entered the specified area by the entering determination unit from among items of the monitoring area mobile object information with the specified area mobile object information.

12. The system according to claim 10, further comprising:
an exiting determination unit which determines whether or not the mobile object has exited the specified area on the basis of position information showing a position of a mobile object in the monitoring area, or position information showing a position of the mobile object in the specified area, wherein
the comparison unit compares monitoring area mobile object information of a mobile object determined to have exited the specified area by the exiting determination unit from among items of the monitoring area mobile object information with the specified area mobile object information.
